(19) United States
(12) Patent Application Publication
(10) Pub. No.: US 2013/0332210 A1
(43) Pub. Date: Dec. 12, 2013

(54) CONTENT MATCHING USING A RULES EVALUATOR

(71) Applicants: Jaroslaw Wyganowski, Fargo, ND (US); David Boline, Eden Prairie, MN (US); Daniel Lothspeich, West Fargo, ND (US); Clifford Hoglund, Deerfield, NH (US)

(72) Inventors: Jaroslaw Wyganowski, Fargo, ND (US); David Boline, Eden Prairie, MN (US); Daniel Lothspeich, West Fargo, ND (US); Clifford Hoglund, Deerfield, NH (US)

(73) Assignee: MICROSOFT CORPORATION, Redmond, WA (US)

(21) Appl. No.: 13/492,929

(22) Filed: Jun. 11, 2012

(51) Int. Cl. G06Q 40/00; G06Q 10/06; G06F 17/30

(52) U.S. Cl. 705/7.13; 707/758; 705/34; 707/E17.014

(57) ABSTRACT

Invoice documents are automatically matched against receipts as part of an automated workflow that executes workflow process steps on a given invoice. A workflow engine is used to determine whether a pending invoice document needs to be matched against a receipt. This can be done using explicit matching information, or using implicit matching. Invoice documents that cannot be matched can be surfaced for user attention. A rules evaluator may also be employed to evaluate received documents.

### BACKGROUND

Many documents are currently created and processed. It is often desired that the documents be matched against one another, at some point during a process. Matching can often be done manually, but this can be quite time consuming and expensive.

By way of one specific example, many organizations generate purchase orders that identify purchases that are made by the organization, from a vendor. The vendor then submits an invoice to the purchasing organization. In addition, when items are shipped from the vendor to the purchasing organization, the vendor includes a receipt for the items shipped. In order to process the invoice for payment (or for any other reason) it may be desirable to match the items listed on the invoice against the items which have been received, as reflected on the receipt. In this way, the purchasing organization can determine whether they have received the items that they ordered on the purchase order, and for which they have been invoiced.

In some current systems, invoices are matched against receipts in a manual way. For instance, a user accesses a business data system on a computer and opens a window that shows outstanding invoices and attempts to find relevant invoices and match them, in another window, against unmatched receipts. In doing so, the user often needs to match individual lines of an invoice against individual lines on one or more different receipts. This is time consuming, and error prone. Once an invoice is matched against a receipt, the invoice and receipt can be subjected to additional automated or manual workflow process steps.

The discussion above is merely provided for general background information and is not intended to be used as an aid in determining the scope of the claimed subject matter.

### SUMMARY

Invoices are automatically matched against receipts as part of an automated workflow that executes workflow process steps on a given invoice. A workflow engine is used to determine whether a pending invoice needs to be matched against a receipt. This can be done using explicit matching information, or using implicit matching. Invoices that cannot be matched can be surfaced for user attention.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business workflow system.

FIG. 2 is a flow diagram illustrating one embodiment of how the system in FIG. 1 is configured to perform automated matching.

FIGS. 2A-2G show user interface displays generated during the configuration of the workflow system to perform automated matching.

FIG. 3 is a flow diagram of one illustrative embodiment of the operation of the system shown in FIG. 1 for processing an invoice.

FIG. 4 is a flow diagram illustrating one embodiment of the operation of the system shown in FIG. 1 in performing automated matching.

FIGS. 5A-7B are exemplary user interface displays showing invoices and receipts that are matched.

FIG. 8 is a block diagram of one illustrative cloud computing architecture.

FIGS. 9-13 illustrate examples of mobile devices.

FIG. 14 is a block diagram of one illustrative embodiment of a computing environment.

### DETAILED DESCRIPTION

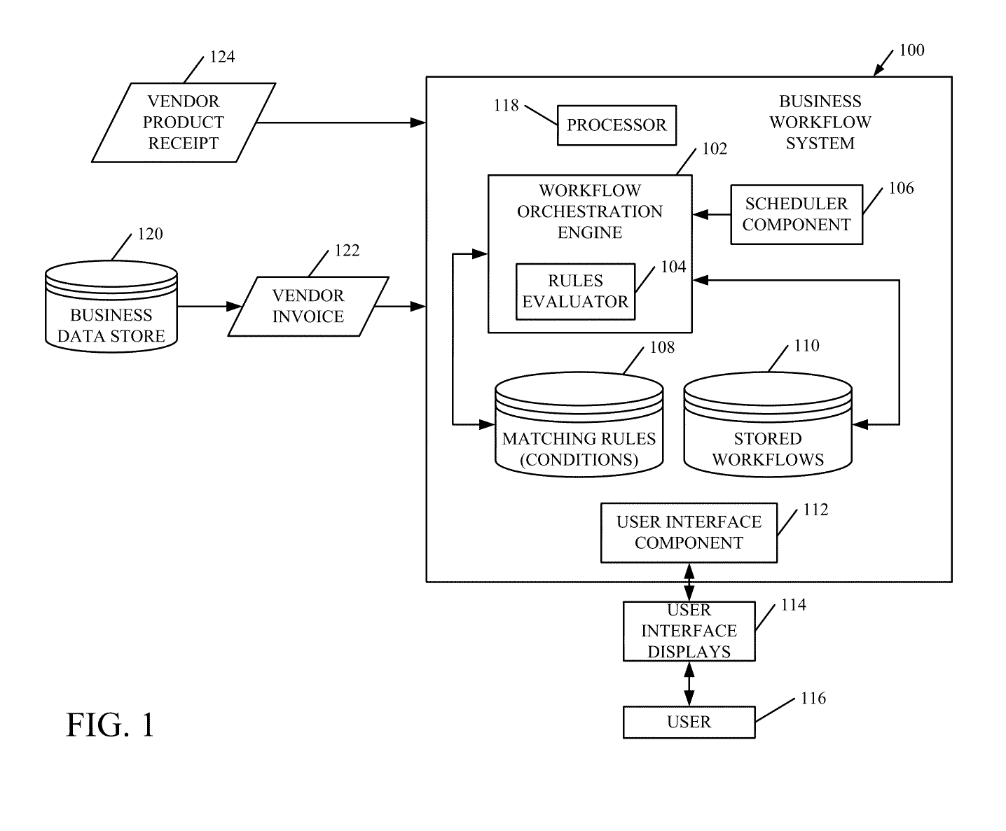

FIG. 1 is a block diagram of one embodiment of a business workflow system 100. It should be noted that system 100 can be in an accounts payable system that is, itself, part of a larger business data system, such as a customer resource management (CRM) system, an enterprise resource planning (ERP) system, a book keeping system, or other business data system.

In the embodiment shown in FIG. 1, business workflow system 100 illustratively includes a workflow orchestration engine 102 that has a rules evaluator 104 and that is coupled to a scheduler component 106. Workflow orchestration engine 102 is shown connected to matching rules (or conditions) data store 108 and stored workflows data store 110. System 100 also illustratively includes a user interface component 112 that generates user interface displays 114 for a user 116. In one embodiment, user interface displays 114 are generated with user input mechanisms that receive user inputs to configure and otherwise operate system 100.

System 100 also illustratively includes processor 118. Processor 118 is illustratively a computer processor with associated timing and memory circuitry (not shown). Processor 118 is illustratively a functional component of system 100 and facilitates the functionality of engine 102, rules evaluator 104, component 106 and user interface component 112, as well as other components of system 100.

In the embodiment shown in FIG. 1, business workflow system 100 is shown coupled to business data store 120 that stores a variety of different types of business data, such as vendor invoice 122 and other invoices received from vendors, purchase orders, general ledger entries, inventory data and a variety of other business data. In one embodiment, system 100 is also shown receiving vendor product receipt 124. Product receipt 124 can be received electronically, or scanned into system 100, or received through a web service, or otherwise. In one embodiment, once it is received, it is stored in business data store 120 for later processing. Of course, it can be stored other places as well.

Once configured, business workflow system 100 receives both vendor invoices 122 and vendor product receipts 124 and automatically matches them against one another by performing a scheduled matching task. Scheduler component 106 controls workflow orchestration engine to perform the matching task, as scheduled. Workflow orchestration engine 102 accesses stored workflows in store 110 and executes those workflows, which themselves can include a scheduled matching task. To perform the scheduled matching task, rules evaluator 104 accesses matching rules (or conditions) in data store 108 to determine whether any matching needs to be performed. If so, it matches vendor invoices 122 against vendor product receipts 124 and generates user interface displays 114 using user interface component 112 to indicate this to the user. In addition, if problem invoices are encountered (such as invoices that cannot be completely matched after a given time period, or other problem invoices) workflow orchestration engine 102 can also bring these to the attention of user 116 through an appropriate user interface display 114.

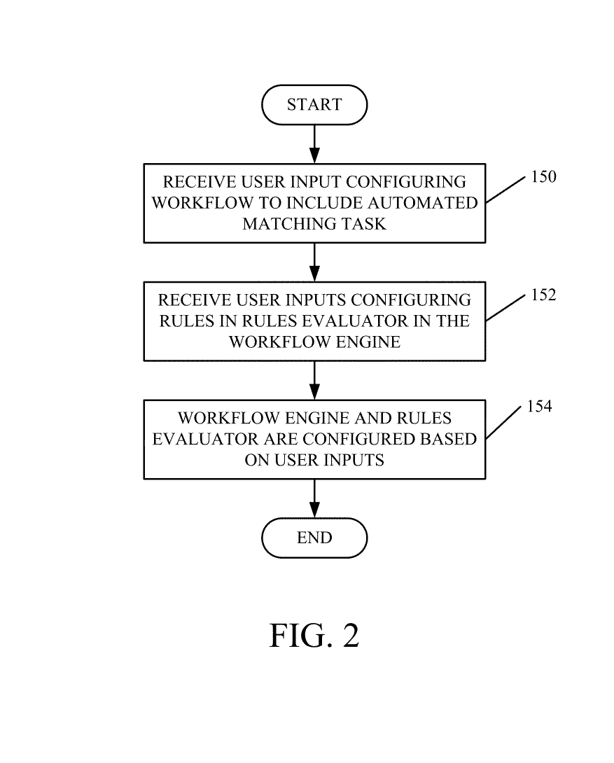

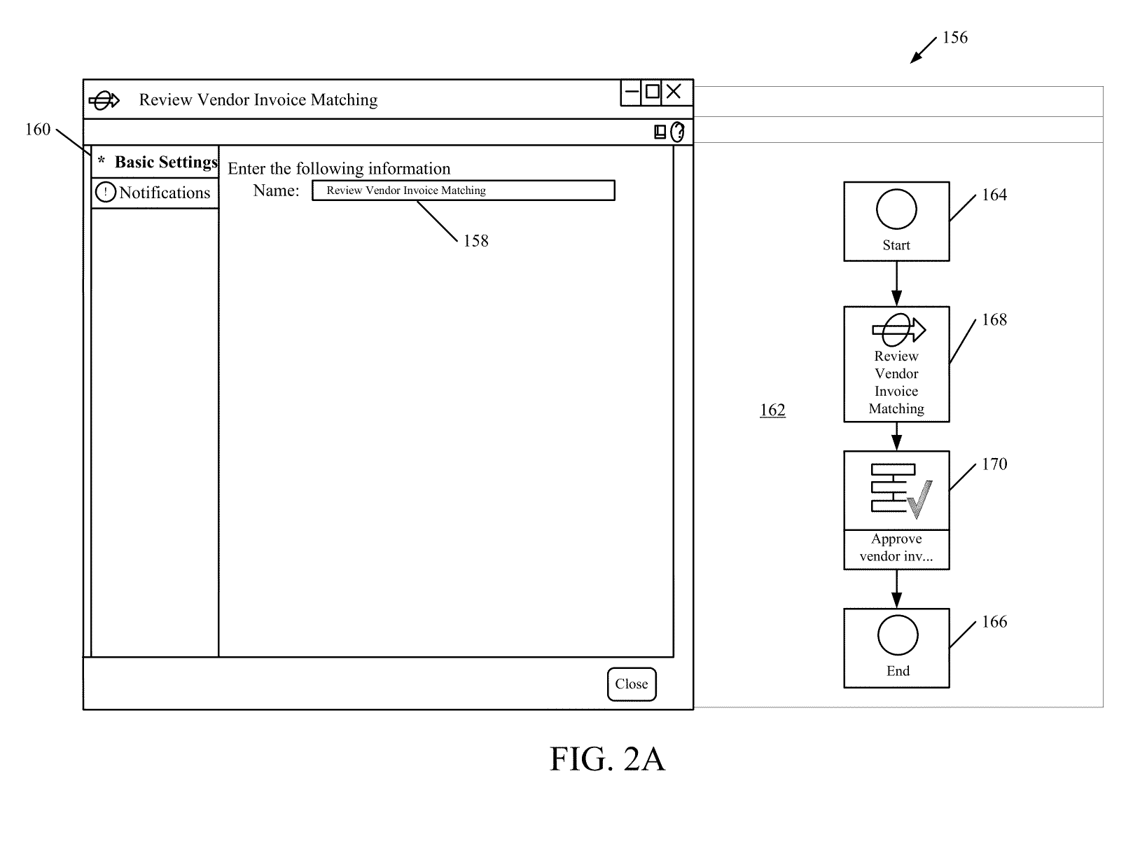

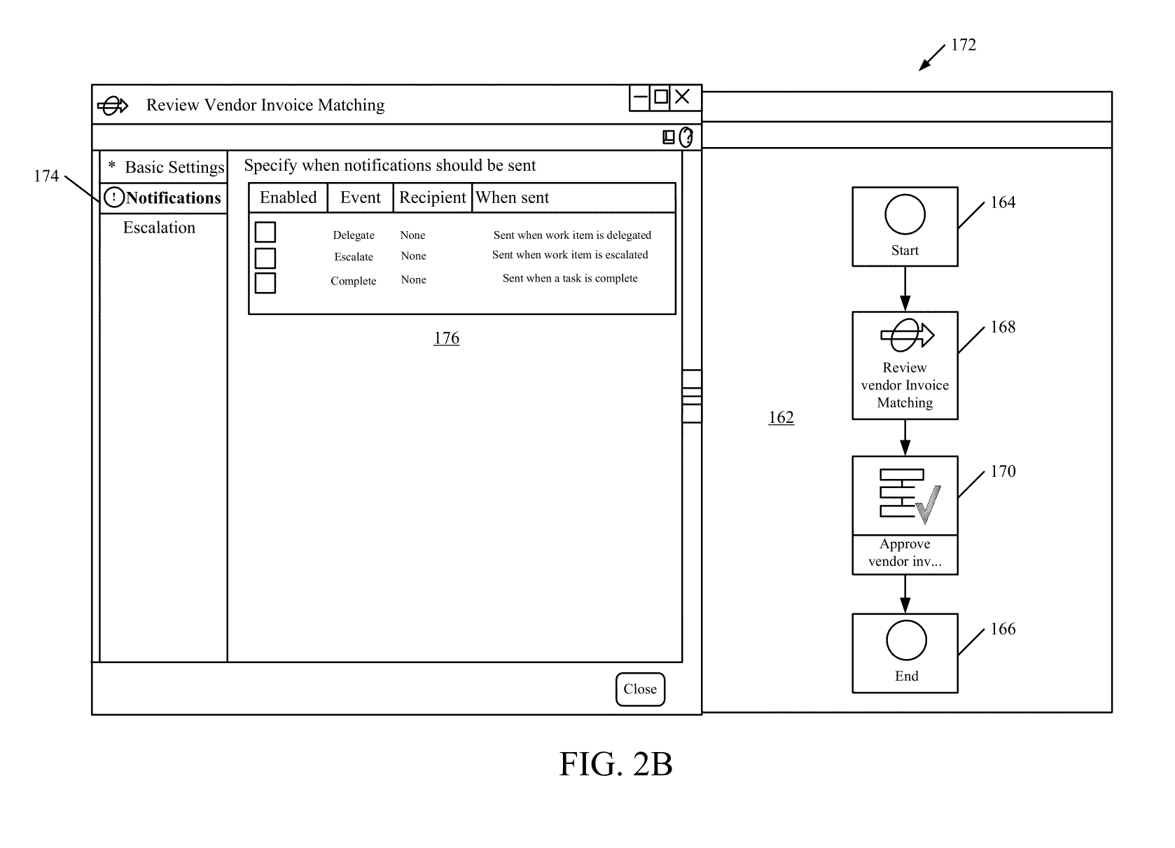

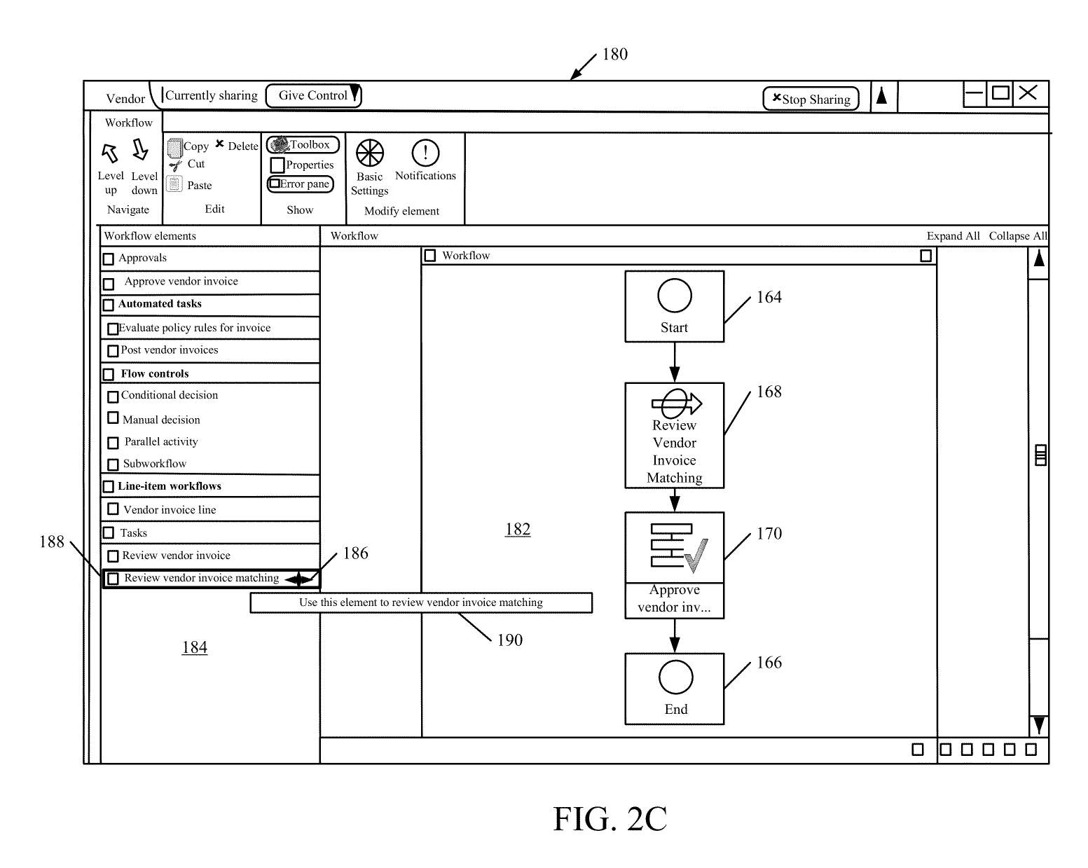

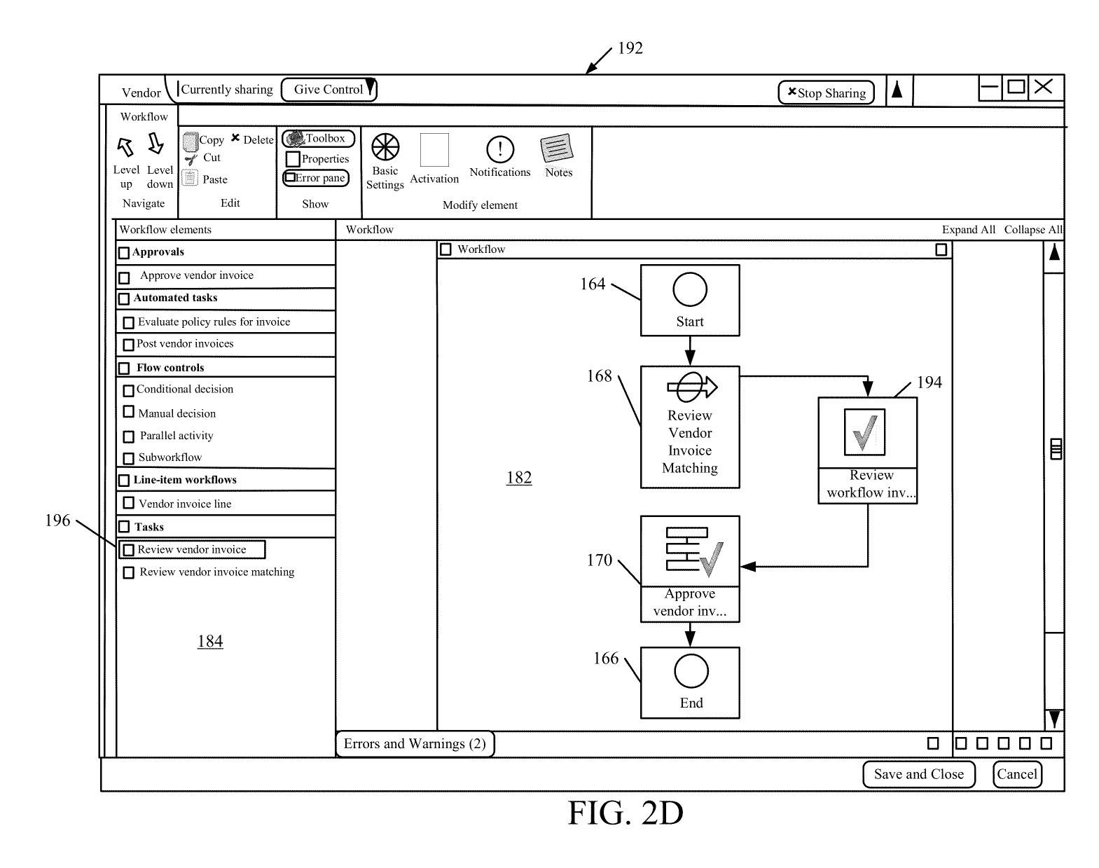

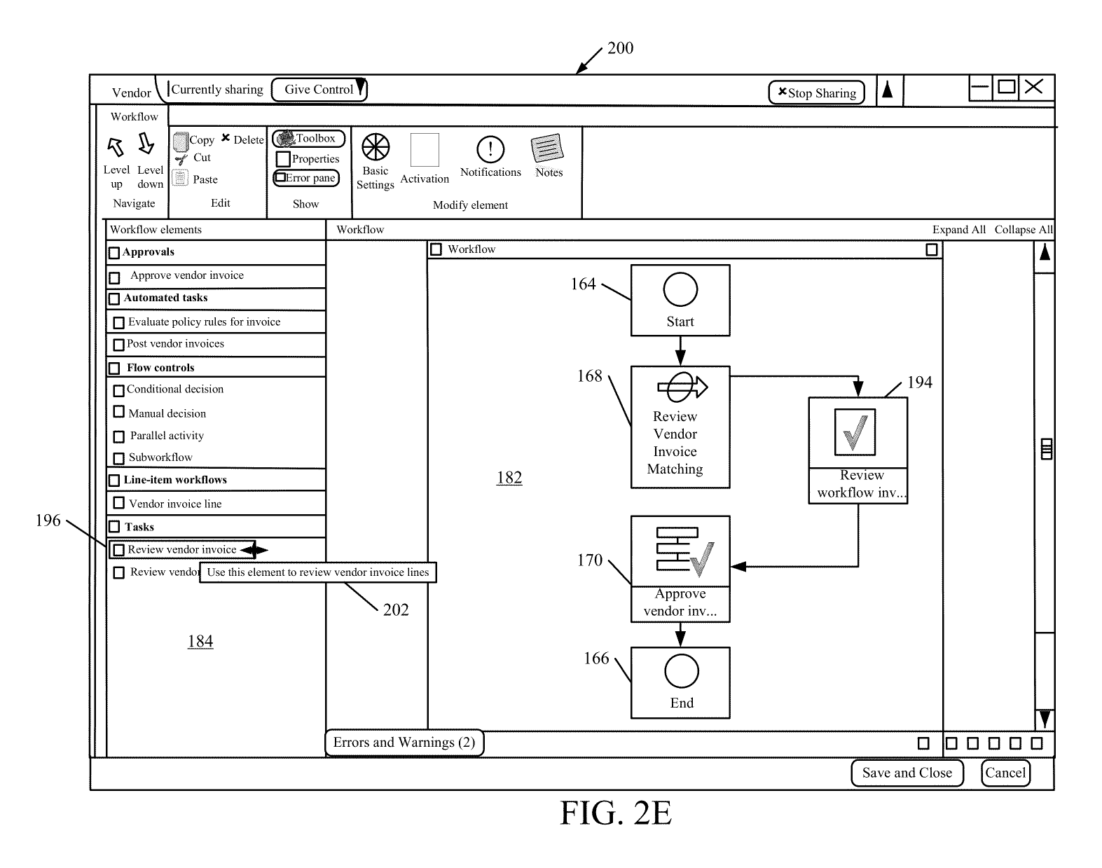

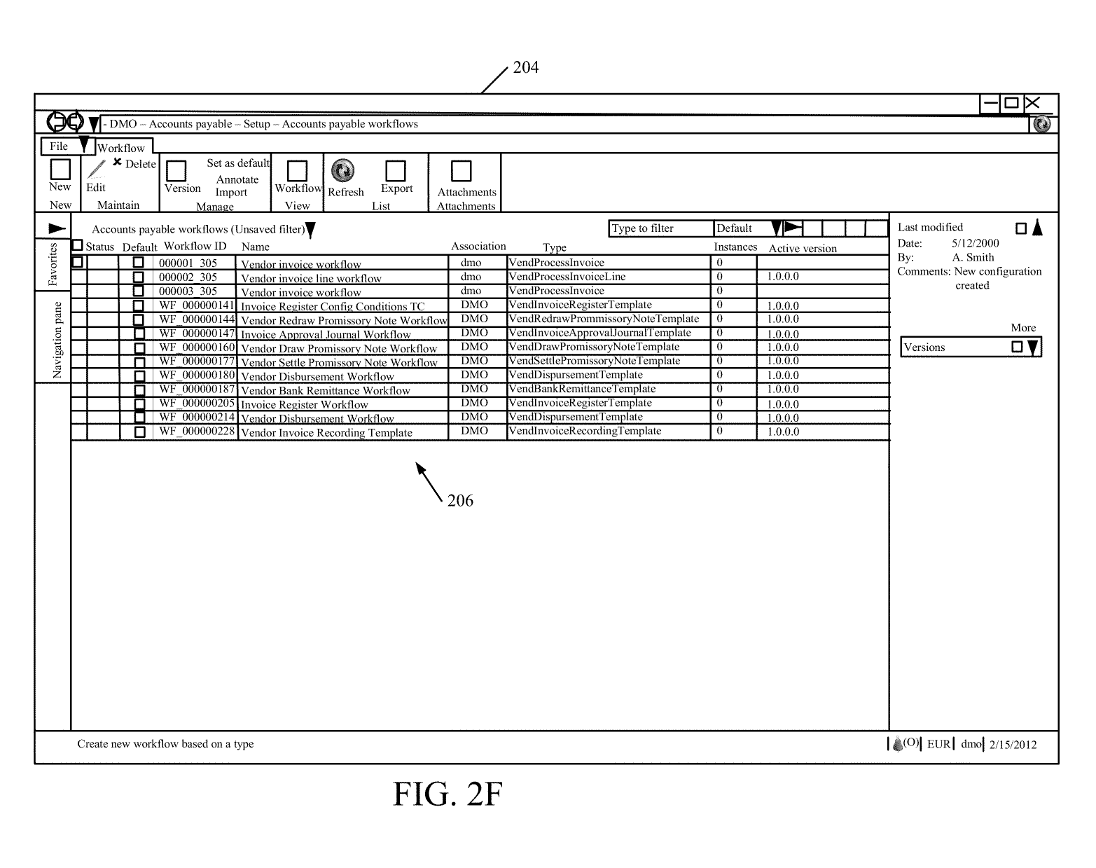

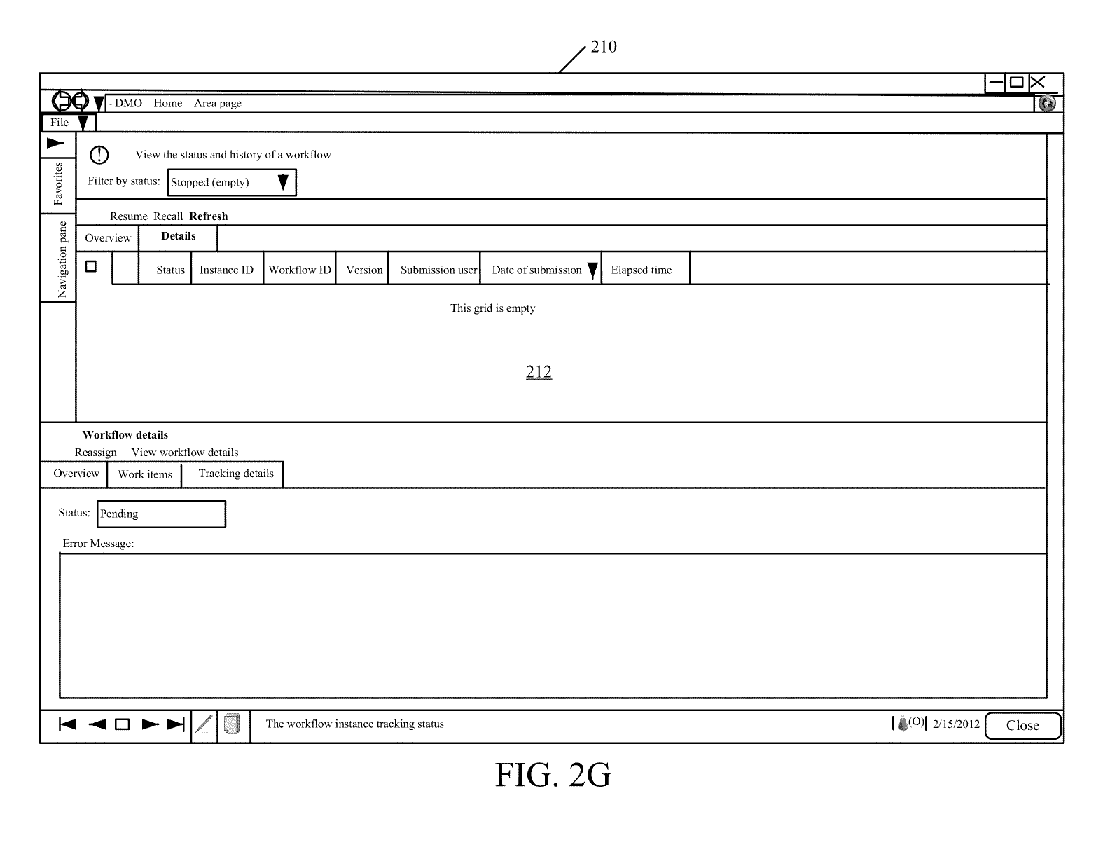

FIG. 2 shows a flow diagram illustrating one embodiment of how workflow orchestration engine 102 and rules evaluator 104 can be configured to perform automated matching. User 116 first provides an input through a user interface display 114 indicating that the user wishes to configure a workflow to include an automated matching task. In response, workflow orchestration engine 102 illustratively generates a set of user interface displays 114, using user interface component 112, which allow user 116 to configure the workflow to include that task. The user then provides user inputs in order to configure the workflow to include the automated matching task. This is indicated by block 150 in FIG. 2. Next, workflow orchestration engine 102 generates a user interface display 114 that allows user 116 to input or select or otherwise modify rules in store 108 that are accessed by rules evaluator 104 in the workflow orchestration engine 102. This is indicated by block 152 in FIG. 2. Recall that rules evaluator 104 accesses these rules in order to determine whether a matching task needs to be performed, and in order to perform that matching task.

Once all of the appropriate user inputs are received, workflow orchestration engine 102 configures the workflow based on the user inputs and stores the workflow in data store 110, for later execution. This is indicated by block 154 in FIG. 2.

FIGS. 2A-2G show a plurality of exemplary user interface displays 114 that are generated during the workflow setup described in FIG. 2. FIG. 2A illustrates one user interface display 156 for configuring workflow orchestration engine 102 to perform the automated matching task. User interface display 156 shows that the automated matching task is referred to as “Review vendor invoice matching” and is set out in text block 158 when the basic settings button 160 is selected by the user. User interface display 156 also includes a workflow display pane 162. As shown in FIG. 2A, the workflow being configured includes a start node 164, an end node 166, along with the automated matching task node 168. The review vendor invoice matching task node 168. The workflow shown in workflow display pane 162 also includes an “approve vendor invoice” node 170 which is another workflow process step once a vendor invoice has been matched against a receipt.

FIG. 2B shows another user interface display 172 that can be generated when the user selects the notifications button 174. In doing so, user interface display 172 includes a notifications display potion 176 that displays when notifications are sent and various events occur. It can be seen in FIG. 2B that, because the automatic invoice matching process uses a non-human system account, recipients of the notification can be set to “none”.

FIG. 2C shows yet another user interface display 180 that shows a workflow pane 182 that is used to display the various nodes in the workflow being configured. Display 180 also includes a workflow list 184 that lists a plurality of different workflow elements that can be used in the workflow being configured, and being displayed in pane 182. In the embodiment shown in FIG. 2C, the user is hovering a cursor 186 over the “review vendor invoice matching” button 188. This illustratively generates a textual definition which, in the embodiment shown in FIG. 2C, is displayed in text box 190, and reads “use this element to review vendor invoice matching.” FIG. 2D shows yet another user interface display 192. In user interface display 192, the workflow shown on pane 182 now includes an additional node, the “review vendor invoices” node 194. This is done by actuating the “review vendor invoices” button 196 from list 184. In one embodiment, the workflow shown in FIG. 2D runs on a per-invoice basis. Once started, the “review vendor invoice matching” node 168 is executed. The element assigns the “review vendor invoice” represented by node 194 to a system user and marks the task as complete when matching is successfully completed. This allows the workflow to proceed to the next node 170 for invoice approval. In one embodiment, the flow proceeds to the next step 170 only when the task 194 is marked as complete.

FIG. 2E shows another user interface display 200, which is similar to user interface display 192 shown in FIG. 2D, and similar items are similarly numbered. However, user interface display 200 also shows the task description 202 that is generated when the user hovers the cursor over the “review vendor invoice” button 196. It can be seen from FIG. 2E that the description 202 reads “use this element to review vendor invoice lines.”

FIG. 2F shows another user interface display 204. User interface display 204 is illustratively an administration form generated by workflow orchestration engine 102 that shows a plurality of different accounts payable workflows in a workflow list 206. When a workflow is generated that includes the automatic matching process, that workflow will, in one embodiment, be listed in workflow list 206 on the administration form in user interface display 204.

FIG. 2G shows another user interface display 210. User interface display 210 is illustratively generated by workflow orchestration engine 102 and shows the history of a specified workflow. In the embodiment shown in FIG. 2G, no workflow is specified and so the history grid 212 is empty. However, if a workflow were specified, the status, instance ID, workflow ID, workflow, version number, scheduling user, date of submission and elapsed time can be generated and displayed in user interface display 210, in order to show the history of that specific workflow. Of course, different elements or other elements or additional elements describing the workflow history can be generated and displayed as well, and user interface display 210 is shown by way of example only.

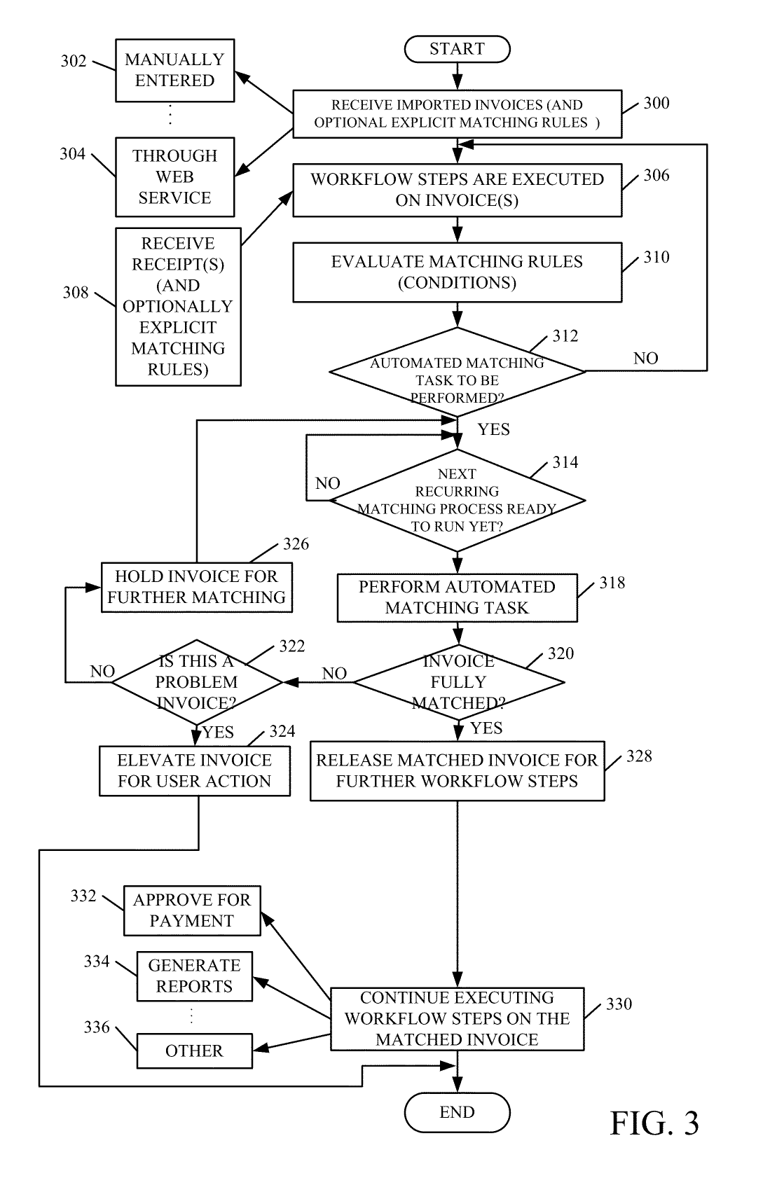

FIG. 3 is a flow diagram illustrating one embodiment of the operation of the system 100 shown in FIG. 1 in performing a workflow that processes an invoice. In one embodiment, the matching task is asynchronous and decoupled from other workflow steps performed on an invoice. Therefore, the workflow can simply wait for matching to be completed, and wait for an automatic callback from the matching task, in order to move to subsequent workflow processing steps. In another embodiment, matching is synchronous. FIG. 3 shows the flow diagram for processing one invoice, asynchronously, but the same matching task and workflow can run concurrently for other invoices as well. In any case, once the workflow is configured as described above with respect to FIGS. 2-2G, various invoices can be processed according to that workflow.

In one embodiment, workflow orchestration engine 102 accesses the stored workflow from data store 110 and begins executing it. In doing so, engine 102 first receives an invoice. This is indicated by block 300 in FIG. 3. The invoice 122 can be manually entered (such as by keying it in using a keyboard or otherwise) or it can be received through a web service or it can be imported into data store 120 or system 100 in a different way. Manually entering the invoice is indicated by block 302 and importing it through a web service is indicated by block 304.

Work flow orchestration engine 102 then begins to perform the workflow tasks on the received invoice. This is indicated by block 306. At some point, a receipt is received and the receipt can optionally include explicit matching rules. The receipt with the explicit matching rules (if they are present) is indicated by block 308 in FIG. 3.

When at least one invoice has been received and a receipt has been received, then rules evaluator 104 evaluates the matching rules (or matching conditions) stored in store 108 to determine whether the automated matching process has sufficient conditions that it can be performed. This is indicated by block 310 in FIG. 3.

By way of example, when configuring the workflow, the user can specify certain conditions which are to be met in order for the automated matching task to begin. For example, one condition for beginning the automated matching task might be that an invoice has been received and has not yet been matched. Another condition may be that the workflow is running on that specific invoice. Yet another condition may be specified in various fields of the invoice. For instance, a rule may be input by the user which indicates that, whenever an invoice from the “ACME Company” is received, the workflow is not to perform the automated matching task, because invoices from that company must be matched by hand. Of course, a wide variety of other matching conditions can be input or configured by the user, as desired.

In any case, rules evaluator 104 evaluates the matching rules (or conditions) and determines whether an automated matching task is to be performed. This is indicated by block 312 in FIG. 3. If not, processing reverts back to block 306 where workflow orchestration engine 102 continues to perform workflow steps on the invoice, or simply suspends the workflow until the conditions are met for running an automated matching task.

If, at block 312, evaluator 104 determines that the conditions exist for an automated matching task to be performed, then engine 102 determines whether the next recurring matching process is ready to run yet. This is indicated by block 314 in FIG. 1. For instance, the user can schedule automated matching tasks to occur at times when business workflow system 100 is not busy doing other things. Of course, the user can schedule the automated matching task to occur substantially any desired time, or recur at specified intervals, or otherwise. In doing so, scheduler component 106 indicates to workflow orchestration engine 102 that the next scheduled matching process is now ready to run.

Once that happens, workflow orchestration engine 102 looks for all receipts that are still unmatched. Orchestration engine 102 then performs automated matching tasks against the invoice, as indicated by block 318. An invoice can be fully matched or partially matched. For example, if the invoice has one line that specifies a quantity of five watches, but matching receipts only reflect that the purchaser received three watches, then the invoice is said to be partially matched. However, if sufficient receipts exist that show the purchaser has received all five watches (i.e., all the items on the invoice are consumed by matching receipts), then the invoice is fully matched. Determining whether the invoice is fully or partially matched is indicated by block 320 in FIG. 3.

If the invoice is only partially matched, then orchestration engine 102 determines whether this particular invoice is a problematic invoice. This is indicated by block 322. An invoice may be a problematic invoice, for instance, if it has gone unmatched for a predetermined length of time. For example, if an invoice has not been fully matched after five business days, it may be identified as a problem invoice. Of course, invoices can be identified as problem invoices for any other desired reason as well.

In any case, if the invoice is identified as a problem invoice, it is elevated through user interface component 112 for inspection and action by user 116. This is indicated by block 324. If not, then processing simply proceeds to block 326 where it is determined that the invoice needs to be held for further matching, and processing reverts to block 314.

It should be noted that, if the invoice currently being matched is not fully matched, the workflow that is executing steps on it can be paused until it is fully matched. By way of example, it may be desirable that a payment is not made on an invoice until all of the products corresponding to that invoice are received. Therefore, the workflow for an unmatched invoice is suspended until it is fully matched. In that way, the invoice will not be paid until all of the corresponding products have been received. This is given by way of example only.

At block 320, it is determined that the invoice is fully matched (meaning that every line on the invoice has been completely matched to lines on one or more receipts), then the matched invoice is released for further workflow steps. This is indicated by block 328 in FIG. 3. Therefore, workflow orchestration engine 102 continues to execute workflow steps on the fully matched invoice. This is indicated by block 330 in FIG. 3. These steps can include approving the invoice for payment, generating reports or other outputs, or other processing steps, as indicated by blocks 332, 334 and 336, respectively.

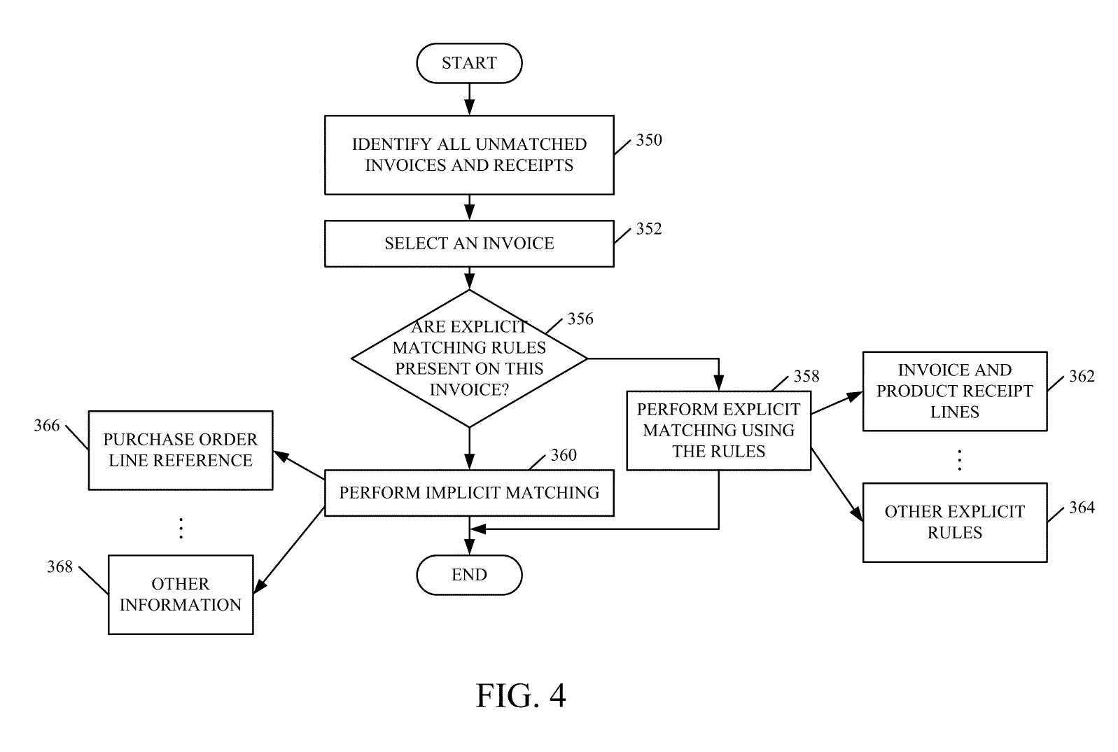

FIG. 4 is a flow diagram illustrating one embodiment of the operation of workflow orchestration engine 102 in performing the automated matching task, in more detail. FIG. 4 shows that, once an automated matching task has begun, engine 102 identifies all unmatched invoices and receipts. This is indicated by block 350 in FIG. 4. Then, an invoice is selected as indicated by block 352.

Workflow orchestration engine 102 then examines the invoice to determine whether it contains any explicit matching rules. This is indicated by block 356 in FIG. 4. If explicit matching rules are present, then workflow orchestration engine 102 performs explicit matching using those rules. This is indicated by block 358. If no explicit matching rules are present, then workflow orchestration engine 102 performs implicit matching, if possible. This is indicated by block 360 in FIG. 4.

One example of explicit matching rules that may be provided on the invoice include receipt numbers attached to each line of the invoice. That is, each line of the invoice specifically identifies the receipt (or a line of the receipt) that reflects the products on that invoice line. The explicit matching rules can be received along with the invoices when the invoices are received, or as part of a schema that defines the invoice. Invoice and product receipt lines that identify one another as explicit matching rules are indicated by block 362 in FIG. 4. Other explicit matching rules are indicated by block 364. It should be noted that, as another embodiment, the receipts can include the explicit matching rules instead of the invoices. For example, each line in a receipt may identify a corresponding invoice line to which it is matched. Other explicit matching rules can be used as well.

Assuming that no explicit matching rules are present, as indicated at block 356, then workflow orchestration engine 102 performs an implicit matching process in order to match invoice lines to receipt lines based on a best estimation. In one embodiment, for example, both invoice lines and receipt lines refer to a purchase order line for a corresponding purchase order. In that embodiment, workflow orchestration engine 102 can examine both the purchase order identifier in an invoice and the purchase order identifier in a receipt, and, where the purchase orders on both match one another, engine 102 can match that specific invoice against that specific receipt. Purchase order line references are indicated by block 366 in FIG. 4. Other information can be used to perform implicit matching as well, and this is indicated by block 368.

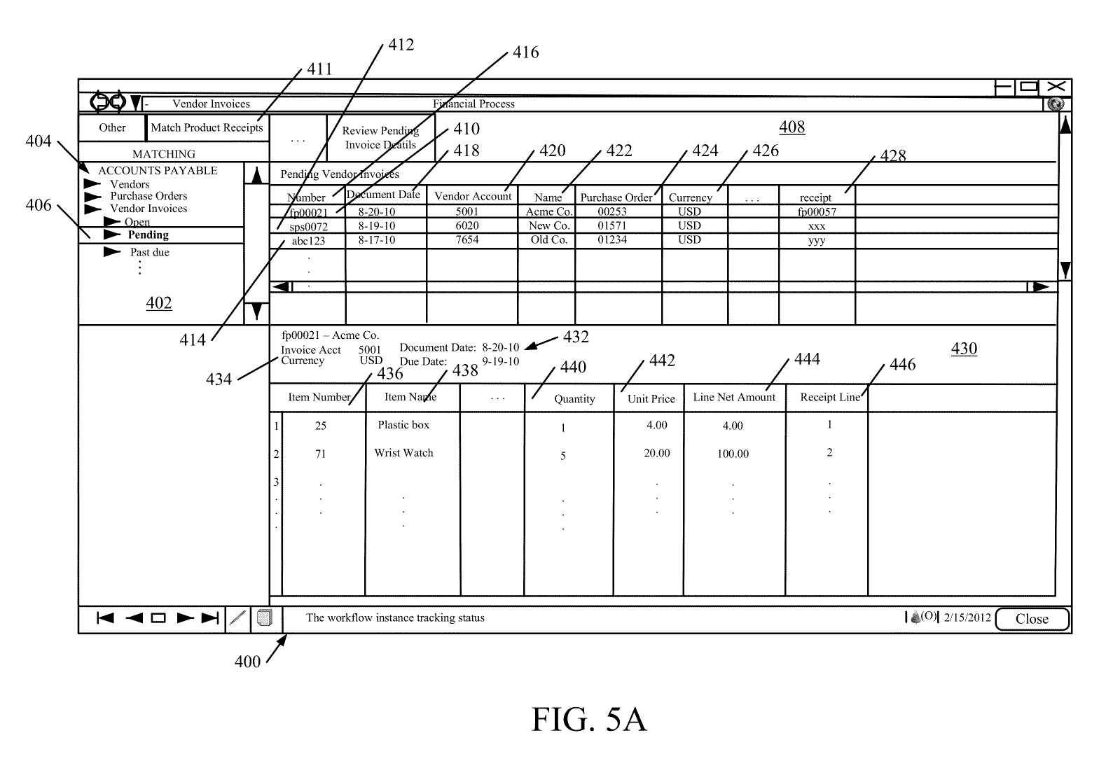

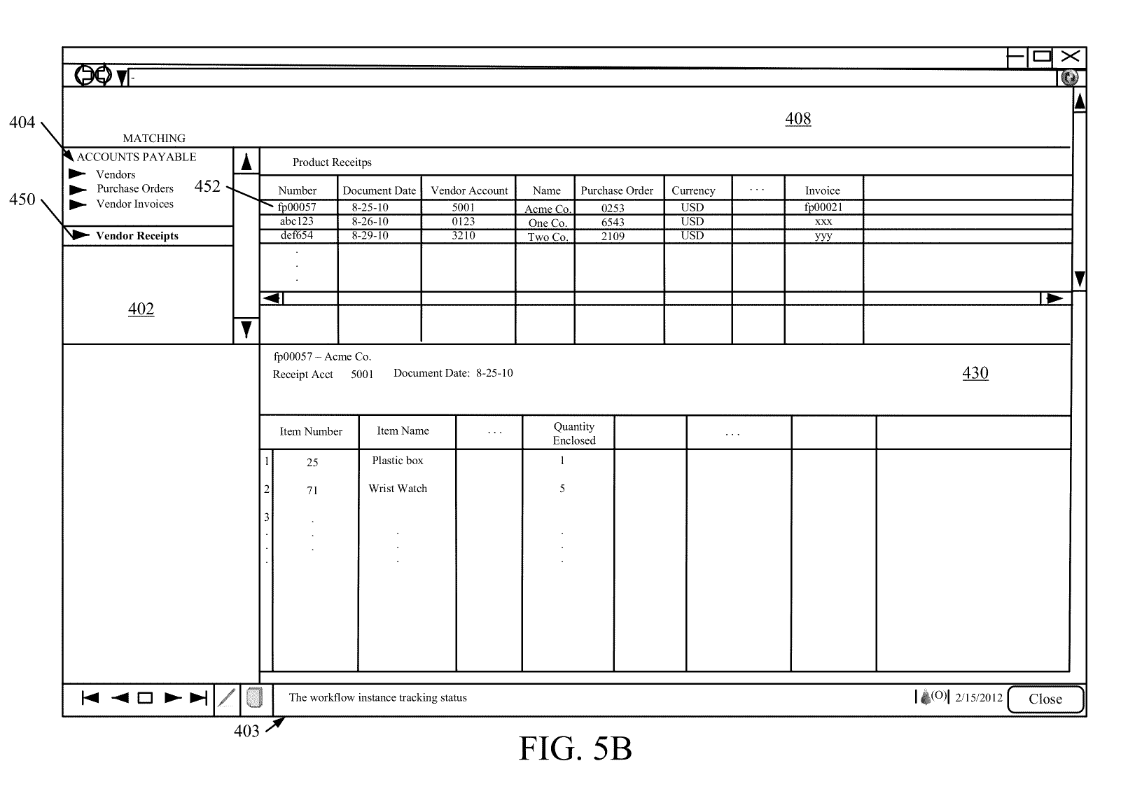

FIGS. 5A-7B show exemplary user interface displays 114 to further illustrate both explicit and implicit matching processes. FIG. 5A shows a user interface display 400 showing a vendor invoice with explicit matching rules, and FIG. 5B is a user interface display 403 of a corresponding receipt that also includes explicit matching rules. Of course, in another embodiment, either the invoice or the receipt contains the explicit matching rules, but not both.

In any case, user interface display 400 includes an account payable section 402 that has a plurality of selectable buttons 404 that allow the user to select a variety of different things for display. It can be seen in FIG. 5A that the pending vendor invoices button 406 has been selected by the user so that display pane 408 displays pending vendor invoices in a plurality of lines 410, 412, and 414. Each line 410-414 corresponds to a separate pending vendor invoice. An invoice is pending when it has not yet been paid.

In the embodiment shown in the user interface display 400, each invoice line includes an invoice number 416, a document date 418 that represents the date the document was created, a vendor account number 420, a vendor name 422, a purchase order number 424 that corresponds to the purchase order for which the invoice was generated, and a currency 426 that identifies the currency that is to be used to pay the invoice. In the embodiment shown in FIG. 5A, each invoice also includes a receipt identifier 428.

The user interface display shown in FIG. 5A also includes a manual matching button 411. Button 411 can be manually actuated by the user to manually initiate an automatic matching process. For instance, if the user has a number of invoices that the user wishes to be matched immediately, so that they can be paid quickly, the user need not wait for the next scheduled matching process, but can initiate the automatic matching process by actuating button 411.

FIG. 5A shows that the user has selected the invoice corresponding to invoice line 410. Thus, the invoice was generated from a vendor named the “ACME Co”, it is based on a purchase order number “00253” and it corresponds to a receipt number fp00057. User interface display 400 also includes an invoice pane 430 that displays information corresponding to the selected invoice (such as the invoice corresponding to line 410) in more detail. It can be seen that pane 430 shows the invoice number and company generally at 432, the invoice account number at 434, and additional information as well. Further, pane 430 shows the invoice detail, such as the item number 436 reflected in the invoice, item name 438, quantity 440, unit price 442 and line net amount 444. In one embodiment, pane 430 also illustrates a receipt line identifier 446.

In the embodiment shown in FIG. 5A, each line item of the invoice corresponds to a receipt identified in receipt field 428, and even a specific line on that receipt as indicated by field 446. For instance, the invoice shown in user interface display 400 and selected at line 410 is an invoice for 1 plastic box with a value of $4.00 and five wrist watches each with a value of $20.00. The plastic boxes will be reflected on line 1 of receipt number fp0057. The wrist watches will be reflected on line 2 of that same receipt. The specific identity of the receipt and the line number for each line of the selected invoice corresponds to the explicit matching rules described above with respect to FIG. 4.

User interface display 403 shown in FIG. 5B is similar, in some ways, to the user interface 400 shown in FIG. 5A, and similar items are similarly numbered. However, user interface display 403 shows that the user has selected the vendor receipts button 450 so that pane 408 now displays a list of vendor receipts. It can be seen that the user has selected the first line 452 of vendor receipts corresponding to receipt number fp0057. Pane 430 shows more detailed information corresponding to the selected receipt number. It can be seen that, as identified in FIG. 5A, line 1 of receipt fp0057 corresponds to one plastic box, and line 2 corresponds to five wrist watches. Thus, in the embodiment where explicit matching rules are used, workflow orchestration engine 102 matches lines 1 and 2 of the receipt shown in user interface display 403 against lines 1 and 2 of the vendor invoice shown in user interface display 400. Because the invoice has one plastic box and five wrist watches, and because the matching receipt also has the same quantity of plastic boxes and wrist watches, the invoice shown in FIG. 5A is fully matched.

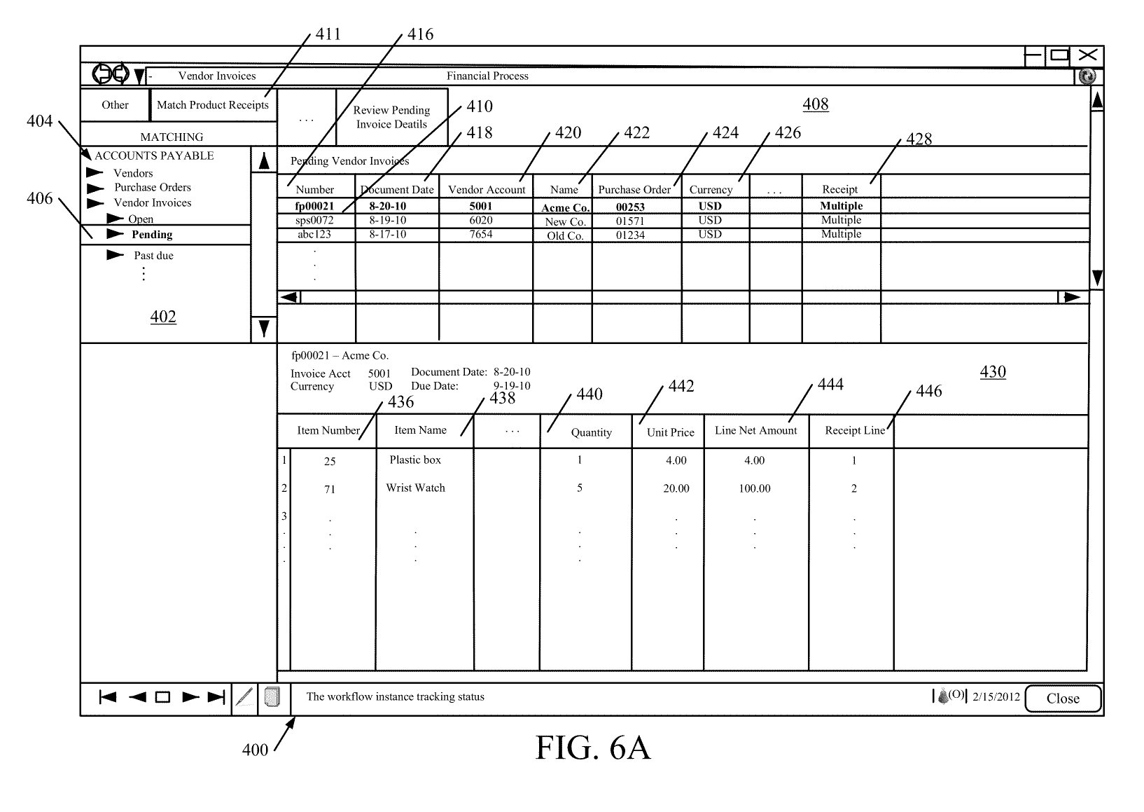

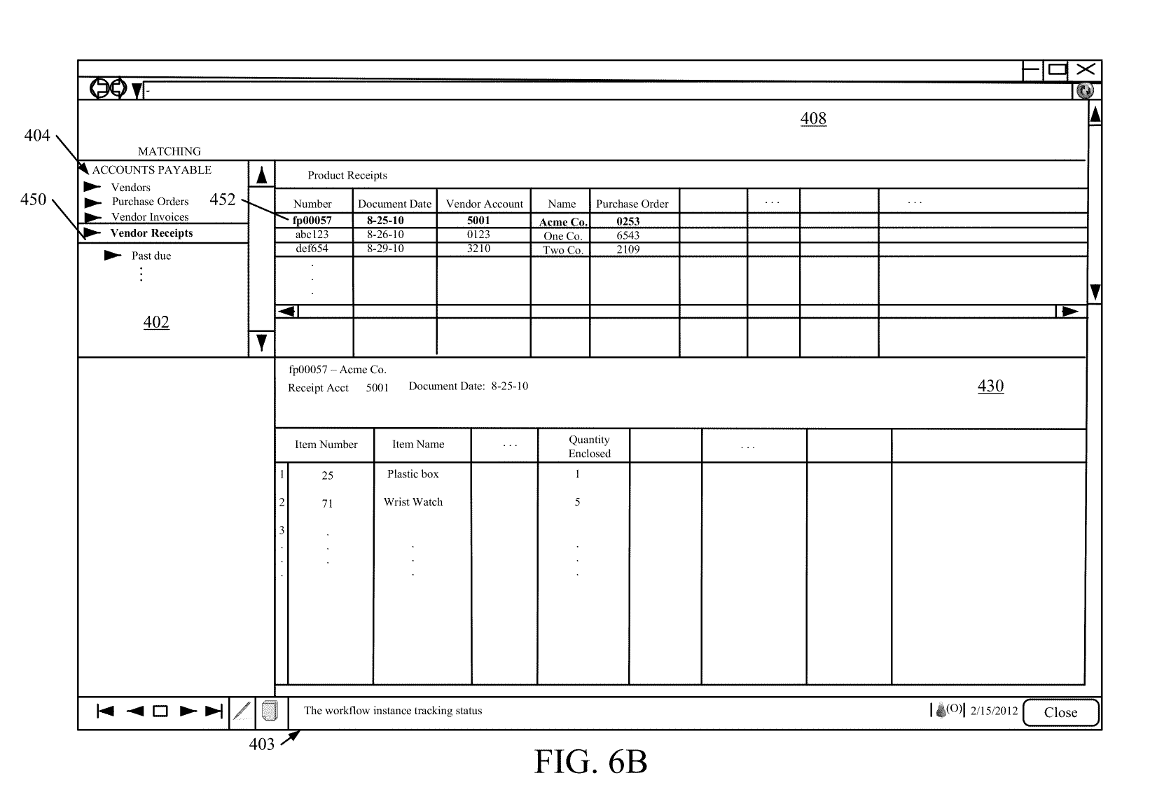

FIGS. 6A and 6B are similar to FIGS. 5A and 5B, and similar items are similarly numbered. However, it can be seen that each invoice in lines 410, 412 and 414 do not include a specific reference to a specific receipt in field 428. In fact, the invoices do not contain any explicit matching rules. Therefore, workflow orchestration engine 102 performs implicit matching on the selected invoice against the various receipts.

It can be seen in FIGS. 6A and 6B that both the selected invoice in FIG. 6A and the selected product receipt in FIG. 6B contain reference to the same purchase order, namely purchase order number 00253. Thus, workflow orchestration engine 102 can at least determine that both the invoice and the receipt correspond to the same purchase order. Workflow orchestration engine 102 then examines the specific items on each line of the invoice and determines whether there are the same items on the receipt. If so, workflow orchestration engine 102 compares the quantities of each item on the invoice against the quantities of each item on the receipt and matches them against one another. In this way, workflow orchestration engine 102 implicitly matches the invoice shown in FIG. 6A against the receipt shown in FIG. 6B.

Other implicit matching can be performed as well. For instance, even if the invoice and receipt do not refer to a purchase order, workflow orchestration engine 102 can examine the customer number and customer name to see if the invoice and receipt were generated by the same organization. If so, workflow orchestration engine 102 can again examine the items and quantities on the given invoice and receipt to determine whether they match. Other implicit matching information can be considered as well.

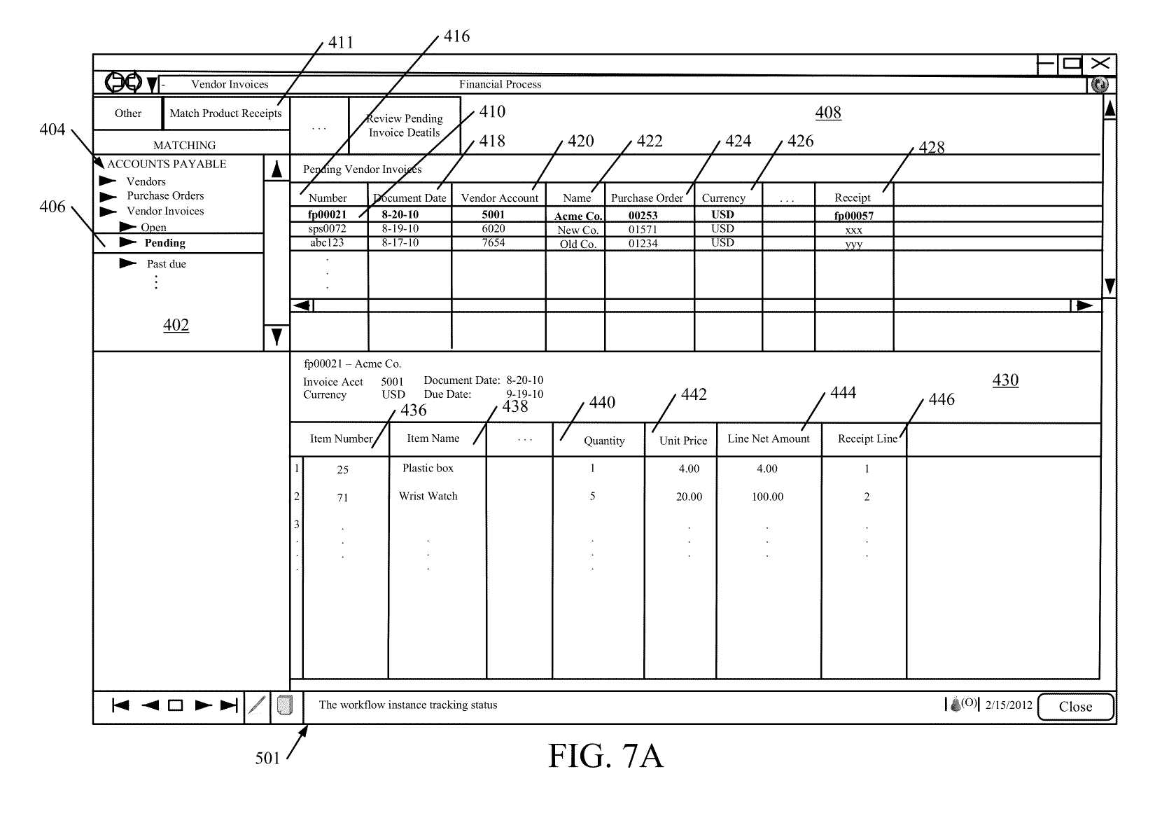

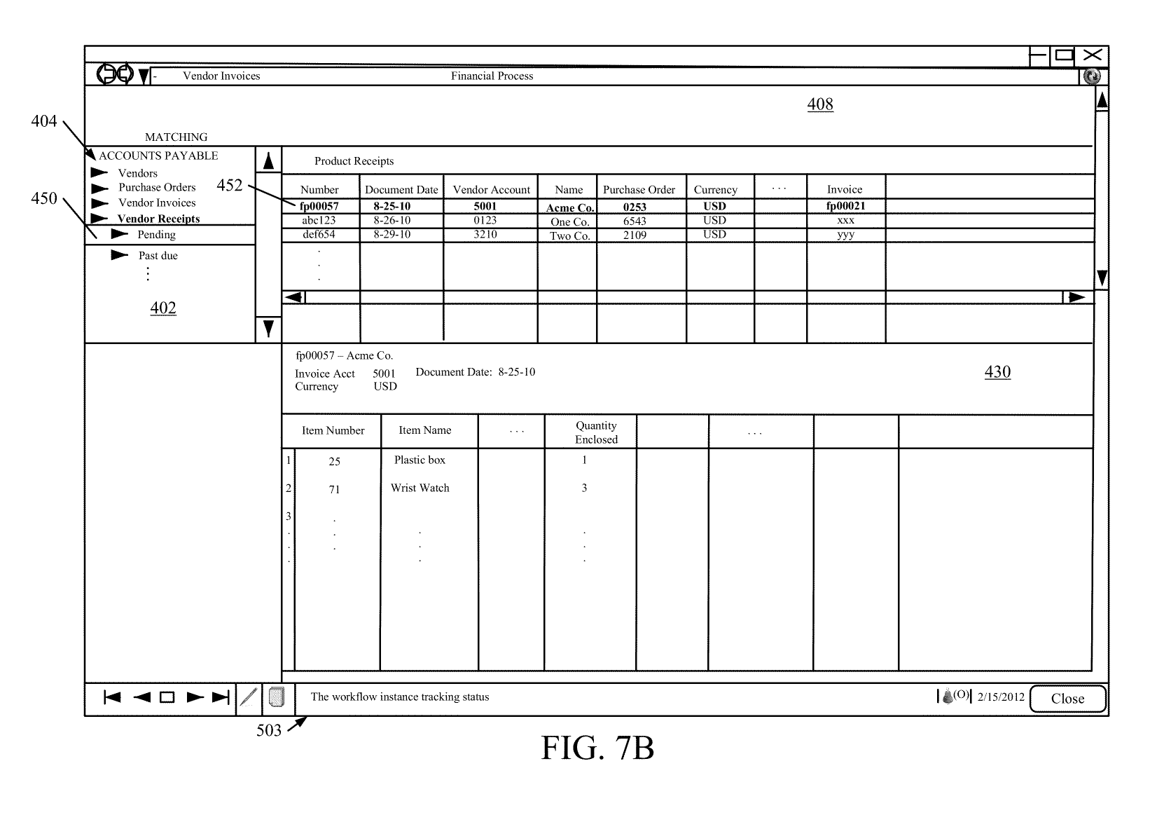

FIGS. 7A and 7B show two other user interfaces 501 and 503 which are similar to user interfaces 400 and 403 shown in FIGS. 5A and 5B, and similar items are similarly numbered. However, the user interfaces 501 and 503 show that the quantities in the receipt shown in user interface display 503 are not the same as the quantities shown in the invoice in user interface display 501. Instead, the invoice shown in user interface display 501 reflects one plastic box and five wrist watches. However, the receipt shows that one plastic box, but only three wrist watches were received. Therefore, regardless of whether the invoice in display 501 is matched against the receipt in display 503 explicitly or implicitly, the invoice is only partially matched. There are still two wrist watches which are not accounted for on any given receipt. In that case, the invoice reflected in user interface display 501 is not released for further workflow processing, but instead engine 102 determines whether it is a problem invoice and should be elevated for explicit user attention. For instance, if the invoice has not been matched for five business days (or some other predetermined amount of time) or for some other desired reason it is labeled as a problem invoice, it can be displayed in an alert, in a message or otherwise, to a user and user attention can be requested with respect to that invoice.

On the other hand, if it is not a problem invoice, but it has simply not been fully matched yet, it is retained as a pending invoice until the next scheduled matching process is run. Once it is fully matched, it is released for further workflow processing.

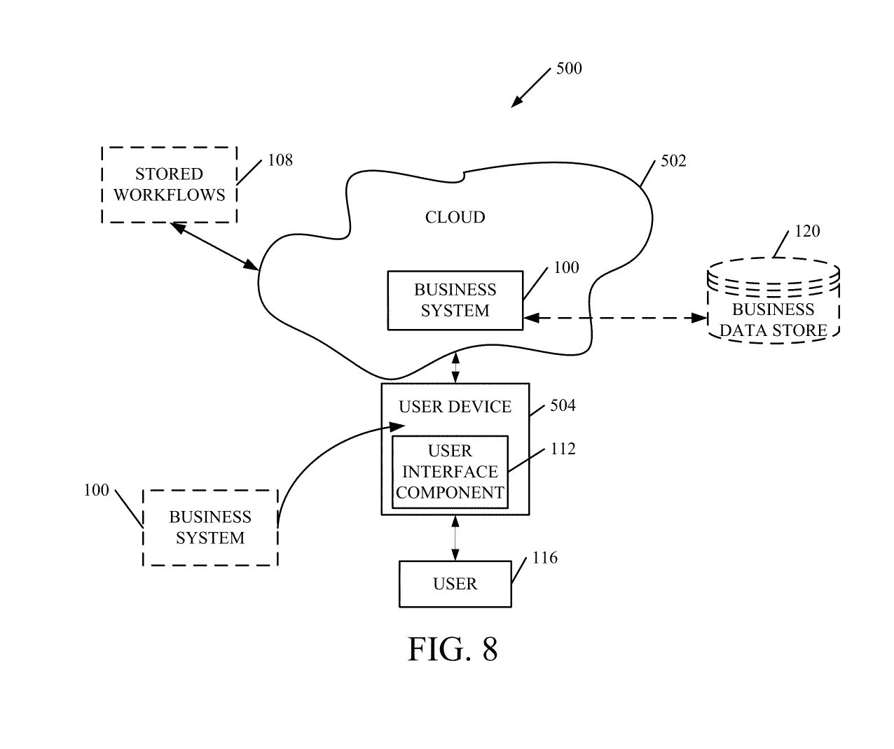

FIG. 8 is a block diagram of system 100, shown in various architectures, including cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

The embodiment shown in FIG. 8, specifically shows that business system 100 is located in cloud 502 (which can be public, private, or a combination where portions are public while others are private). Therefore, user 116 uses a user device 504 to access those systems through cloud 502.

FIG. 8 also depicts another embodiment of a cloud architecture. FIG. 8 shows that it is also contemplated that some elements of business system 100 are disposed in cloud 502 while others are not. By way of example, data store 120 or workflows 110 can be disposed outside of cloud 502, and accessed through cloud 502. In another embodiment, some or all of the components of system 100 are also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

FIG. 8 further shows that some or all of the portions of system 100 can be located on device 504.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

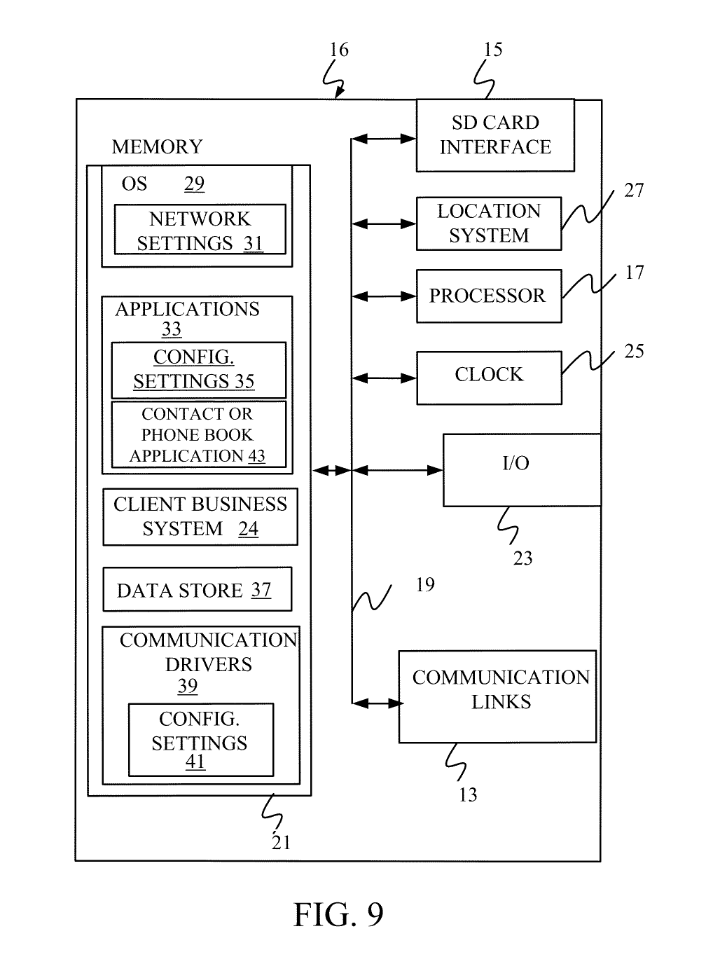

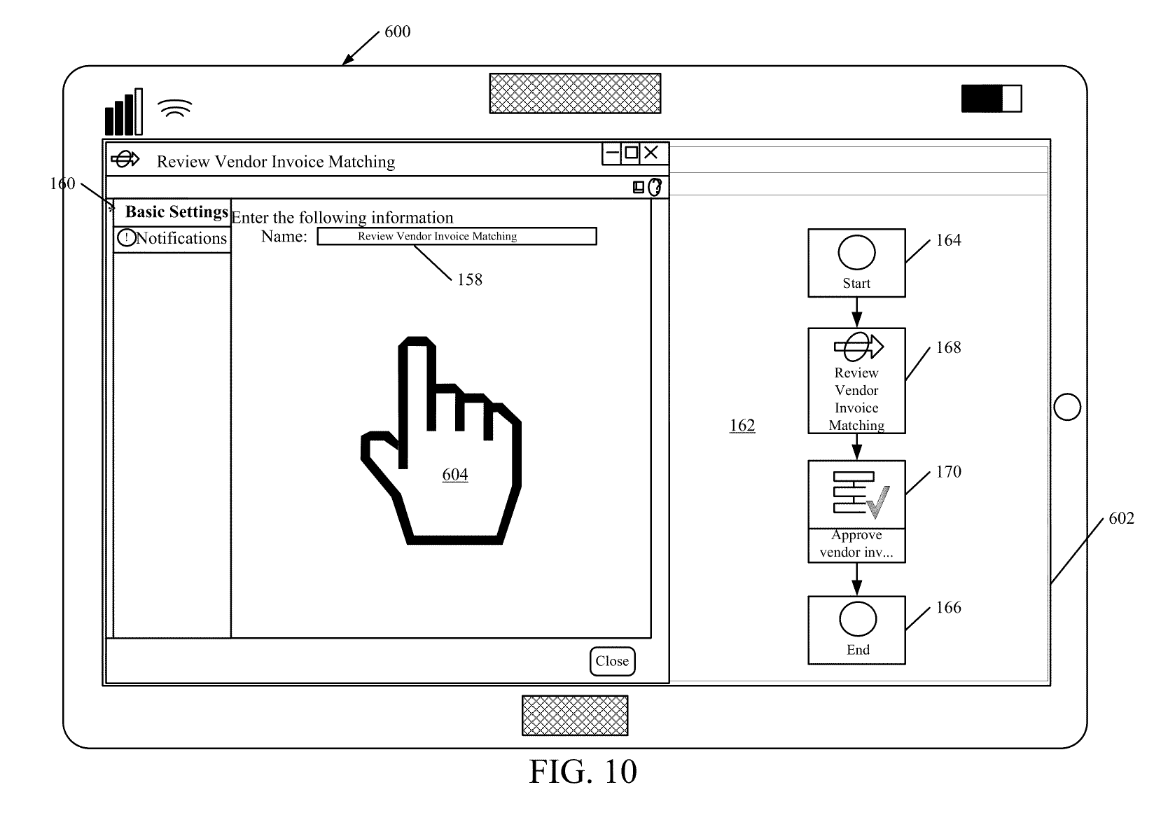

FIG. 9 is a simplified block diagram of one illustrative embodiment of a handheld or mobile computing device that can be used as a user's or client's hand held device 16, in which the present system (or parts of it) can be deployed. FIGS. 10-13 are examples of handheld or mobile devices.

FIG. 9 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processor 118 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 120, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

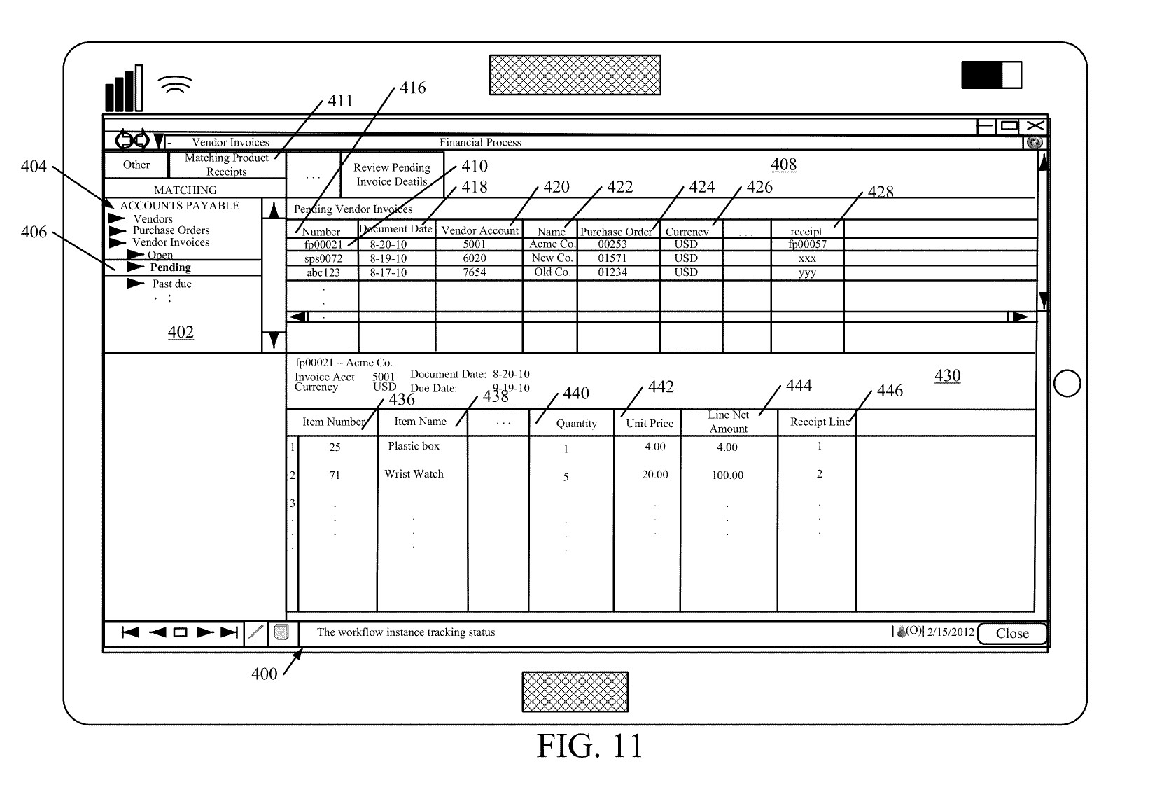

FIGS. 10 and 11 show one embodiment in which device 16 is a tablet computer 600. In FIG. 10, computer 600 is shown with the user interface display of FIG. 2A on display screen 602, while FIG. 11 shows computer 600 with the display of FIG. 5A on screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

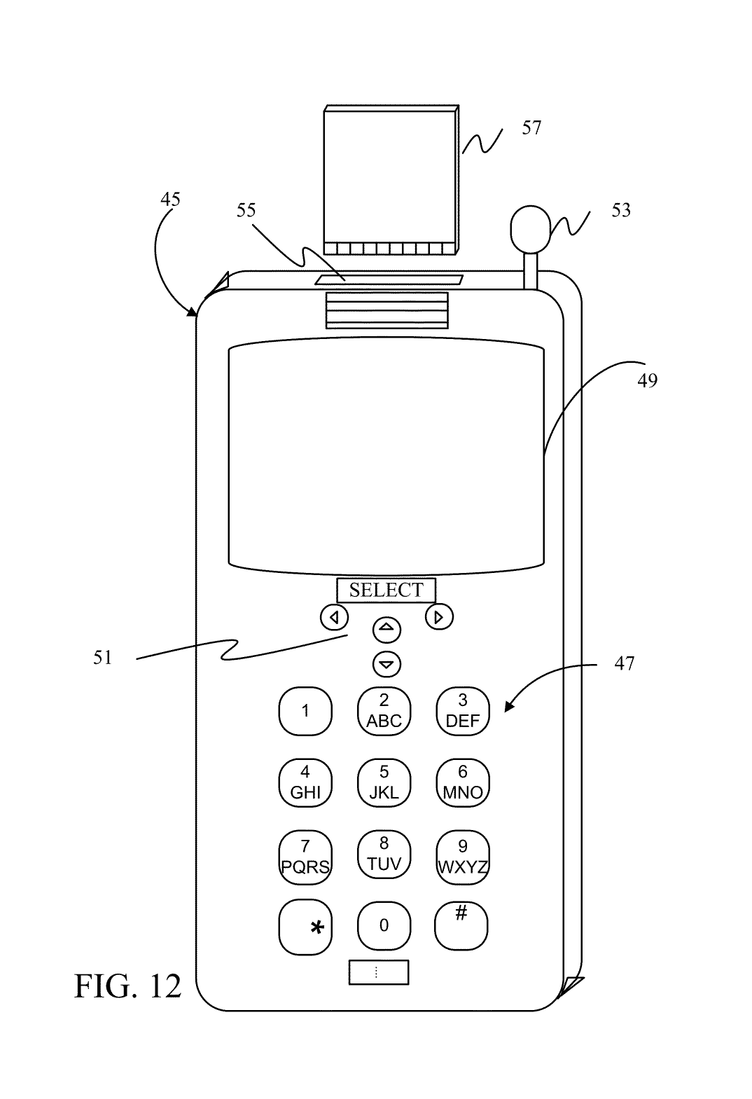

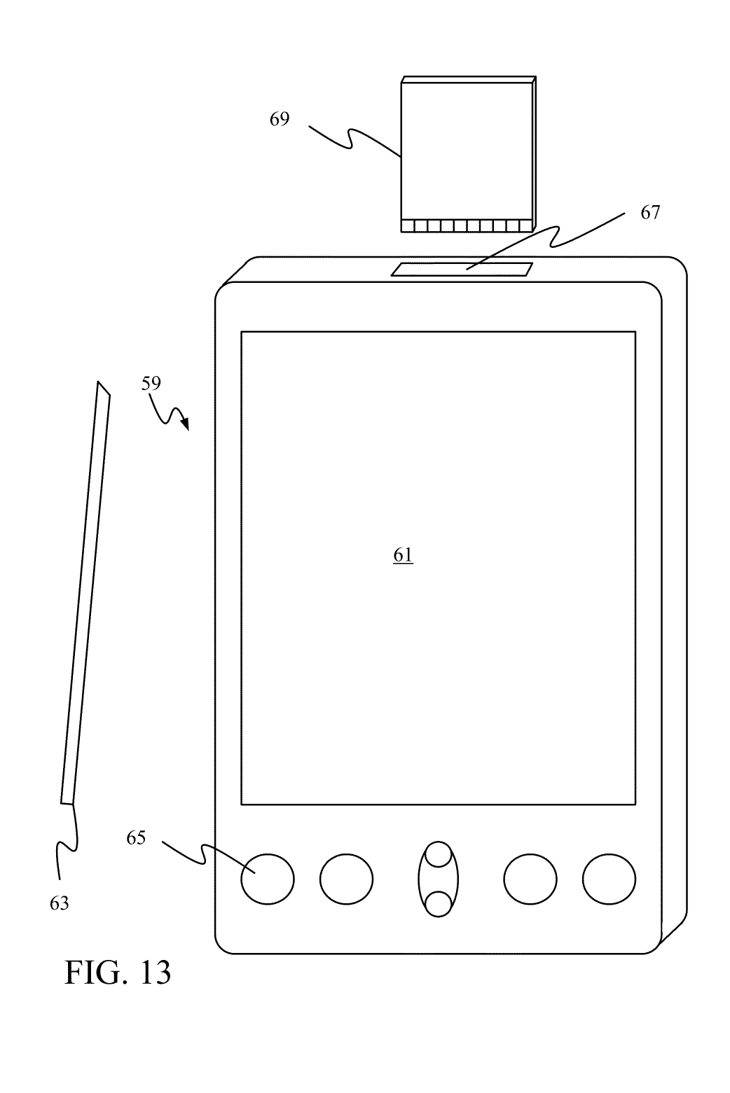

FIGS. 12 and 13 provide additional examples of devices 16 that can be used, although others can be used as well. In FIG. 12, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 13 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the device 16 are possible.

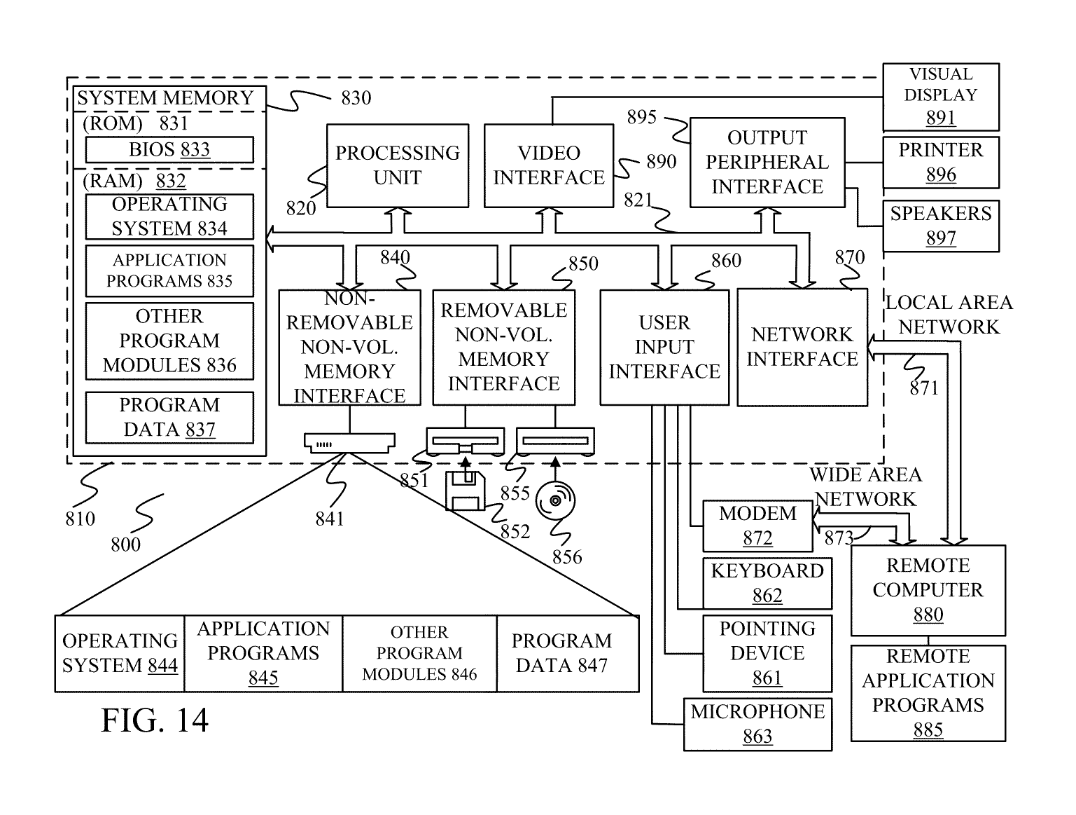

FIG. 14 is one embodiment of a computing environment in which system 100 (for example) can be deployed. With reference to FIG. 14, an exemplary system for implementing some embodiments includes a general-purpose computing device in the form of a computer 810. Components of computer 810 may include, but are not limited to, a processing unit 820 (which can comprise processor 118), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 14.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 14 illustrates operating system 834, application programs 835, other program modules 836, and program data 837.

The computer 810 may also include other removable/non-removable volatile/nonvolatile computer storage media. By way of example only, FIG. 14 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 14, provide storage of computer readable instructions, data structures, program modules and other data for the computer 810. In FIG. 14, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 14 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of matching documents against one another, comprising:
generating, with a computer processor, a user interface configuration display, on a display device, with a user input mechanism receiving user configuration inputs to configure a workflow to include an automated matching task, the user interface configuration display including a first pane with a plurality of different nodes, each node representing a part of the workflow being configured, and a second pane with a plurality of different workflow elements that can be added to the workflow being configured;
receiving, at the computer processor, through the user input mechanism, a first user configuration input configuring the workflow to include the automated matching task, the user interface configuration display being updated to include a node corresponding to the automated matching task in the workflow being configured;
receiving, at the computer processor, a second user configuration input configuring a rules evaluator to evaluate received documents to determine whether the automated matching task is to be performed;
receiving first and second documents to be matched;
evaluating, with the computer processor, the first and second documents with the rules evaluator; and
if the rules evaluator determines that the automated matching task is to be performed, automatically matching the first and second documents against one another, using the computer processor.

2. The computer-implemented method of claim 1 wherein the first document comprises an invoice with a set of lines, each line including a quantity of an item and wherein the second document comprises a receipt with a set of lines, each line including a quantity of an item.

3. The computer-implemented method of claim 2 wherein automatically matching the first and second documents against one another comprises:
automatically matching the lines of the invoice against the lines of the receipt.

4. The computer-implemented method of claim 3 wherein automatically matching the lines of the invoice against the lines of the receipt comprises:
identifying which given line of the receipt corresponds to which given line of the invoice; and
determining whether the quantity of items in the given line of the invoice is the same as the quantity of items in the given line of the receipt.

5. The computer-implemented method of claim 4 wherein if determining whether the quantity of items in the given line of the invoice is the same as the quantity of items in the given line of the receipt then determining that the invoice is fully matched; and
releasing the invoice for further processing steps in the workflow.

6. The computer-implemented method of claim 4 wherein if it is determined that the quantity of items in the given line of the invoice is not the same as the quantity of items in the given line of the receipt, then:
determining that the invoice was partially matched;
determining whether the partially matched invoice is to be surfaced for user attention; and
if so, generating a user interface display of the partially matched invoice;
otherwise, retaining the partially matched invoice for processing during a subsequent automated matching task.

7. The computer-implemented method of claim 6 wherein retaining comprises:
receiving additional receipts; and
automatically matching an unmatched portion of the partially matched invoice to the additional receipts.

8. The computer-implemented method of claim 4 wherein identifying which given line of the invoice corresponds to which given line of the receipt comprises:
comparing an explicit reference to a receipt, corresponding to the given line of the invoice, with the receipt to identify a line of the receipt that matches the explicit reference to the receipt.

9. The computer-implemented method of claim 3 wherein automatically matching comprises:
comparing an explicit reference to a receipt corresponding to each line in the set of lines in the invoice with the receipt to identify which lines of the invoice match which lines of the receipt.

10. The computer-implemented method of claim 3 wherein receiving first and second documents comprises receiving a plurality of receipts and wherein automatically matching comprises:
automatically matching the lines of the invoice against lines in the plurality of receipts.

11. The computer-implemented method of claim 4 wherein identifying which given line of the invoice corresponds to which given line of the receipt comprises:
comparing a reference to something other than a receipt on the given line of the invoice to a reference to something other than an invoice on the given line of the receipt.

12. The computer-implemented method of claim 11 wherein the given line of the receipt and the given line of the invoice both have a purchase order reference referring to a purchase order.

13. The computer-implemented method of claim 12 wherein comparing the reference to something other than a receipt with the reference to something other than an invoice comprises:
comparing the purchase order references on the given line of the invoice and on the given line of the receipt.

14. The computer-implemented method of claim 3 wherein receiving a second user configuration input comprises:
receiving a rules input specifying rules to evaluate to determine whether the automated matching task is to be performed.

15. The computer-implemented method of claim 3 and further comprising:
generating a report indicative of a result of running the automated matching task.

16. The computer-implemented method of claim 1 and further comprising:
receiving a user scheduling input at a scheduler indicating when the automated matching task is to be performed.

17. The computer-implemented method of claim 16 and further comprising:
receiving a plurality of invoices and a plurality of receipts; and
when the rules evaluator and the scheduler determine that the automated matching task is to be performed, automatically matching lines of each of the plurality of invoices against lines of each of the plurality of receipts.

18. A business workflow system, comprising:
a workflow orchestration engine that generates a user interface display that receives user inputs configuring a workflow to include an automated matching task, the workflow orchestration engine performing workflow steps, according to the workflow, on invoices and including a rules evaluator that evaluates matching rules to determine whether the invoices are to be automatically matched against receipts;
a scheduler component scheduling the automated matching task as a scheduled, recurring task and indicating when the workflow orchestration engine is to begin performing an automated matching task, the workflow orchestration engine performing the automatic matching task by automatically matching lines in a given invoice against lines in the receipts in response to the rules evaluator determining that the invoices are to be automatically matched against the receipts and the scheduler indicating that the workflow orchestration engine is to perform the automated matching task; and
a computer processor being a functional component of the system and activated by the workflow orchestration engine and the scheduler component to facilitate performing the workflow steps and scheduling.

19. The business workflow system of claim 18 wherein the workflow orchestration engine matches the lines in the given invoice against lines in the receipts based on both explicit references in the lines in the given invoice to specific receipts and references in the invoice and the receipts to a common purchase order.

20. A computer storage medium that stores computer executable instructions which, when executed by a computer, cause the computer to perform steps of:
generating a user configuration input display with a user input mechanism that receives user configuration inputs to configure a workflow to:
perform workflow steps on a given invoice, the workflow steps including an automated matching task that matches a quantity of items on lines in the given invoice against a quantity of items on lines in a plurality of different receipts;
evaluate a set of matching rules to determine whether invoices meet conditions for performing the automated matching task; and
schedule the automated matching task as a recurring task to occur on a given time interval;
receiving an invoice and a plurality of receipts; and
performing the automated matching task, when scheduled, based on the evaluation of the set of matching rules by matching the lines in the given invoice against lines in the receipts based on both explicit references in the lines in the given invoice to specific receipts and references in the invoice and the receipts to a common purchase order.
